(19) United States
(12) Patent Application Publication
(10) Pub. No.: US 2013/0052173 A1
(43) Pub. Date: Feb. 28, 2013

(54) USE OF MENADIONE AND DERIVATIVES THEREOF FOR TREATING BIOMASSES

(71) Applicant: Paolo Alberto Manzotti, Monza (IT)

(72) Inventor: Paolo Alberto Manzotti, Monza (IT)

(21) Appl. No.: 13/509,263

(22) PCT Filed: Jul. 2, 2010
(86) PCT No.: PCT/IB10/53053

§ 371 Date: May 10, 2012

(30) Foreign Application Priority Data
Mar. 25, 2010 (IT) MI2010A000497

(51) Int. Cl. A01N 35/06; A01N 43/40; A23K 1/16; A01P 1/00; A23K 1/06; A01N 43/54; A01N 57/14

(52) U.S. Cl. 424/93.51; 514/682; 514/274; 514/355; 514/107; 514/356; 426/532

(57) ABSTRACT

A method for limiting the growth of microorganisms in a biomass that can he used for, or is the result of, the production of biofuels by treating said biomass with a compound selected from the group constituted by menadione, menadione derivatives and mixtures thereof.

### TECHNICAL FIELD

The present invention relates to the treatment of biomasses, particularly of biomasses that can be used for, or are the result of the production of biofuels, for limiting the growth of microorganisms.

### BACKGROUND ART

Since immemorial time, human economic activity has been aimed at exploiting and using resources available in nature both for food use and for industrial use. In this context, the collection, storage and treatment of biomasses of vegetable origin have often been activities that have had to deal with the rapid deterioration of said biomasses, which due to their biological origin carry a microbial burden that interferes with the processes for the preservation and even the treatment of said biomasses. Among others, a remarkable case that has become conspicuous in the course of the last decade is the case of biomasses used as a source of renewable energy (biofuels). One of the procedures most widely used for the production of biofuel is the procedure of bioethanol obtained by fermentation by using, for example, beer yeast (Saccharomyces cerevisiae) starting from easily fermentable biomasses that are particularly rich in carbohydrates (still slops, molasses, flours and starches of cereals). Said yeasts, as a result of metabolic transformations, convert the carbohydrates into ethyl alcohol, which is subsequently separated by distillation.

The fermentation process can be hindered by the presence, within the biomasses, of bacteria and microorganisms that feed on the same substrate as the yeast but produce, as catabolites, organic acids such as acetic acid, lactic acid, etcetera.

The development of these competing fermentations on the one hand reduces the quantity of substrate available for the yeast and on the other hand can inhibit, due to an excessive acidification of the mass, the growth itself of the yeast. The final result is in any case a lowering of the ethanol yield of the process. To prevent the unwanted bacterial fermentation described above from occurring before the yeasts have begun to reproduce, it is an established practice to add antibiotics to the fermentation reactors. Traditional antibiotics in fact inhibit the growth of bacteria without preventing the growth of yeasts. The antibiotics commonly used are penicillin, virginiamycin, erythromycin and tylosin.

As a consequence of the addition of antibiotics, the residues of fermentation (for example spent yeasts, distillers, Dried Distillers Grains with Solubles or DDGS), which are almost entirely destined to livestock feeding, can be contaminated significantly by residues of antibiotics. This phenomenon has created and is creating considerable problems for the industry. In recent years, the European Community has banned the use of antibiotics as growth promoters in zootechnical feeds, in order to avoid the onset of phenomena of bacterial resistance to antibiotics.

The possibility of banning the use of antibiotics as growth promoting additives is being considered in the United States as well.

As a consequence of the presence of byproducts contaminated with antibiotics, the bioethanol industry, and the industry based on fermentation processes in general, is confronted with the urgent need to find alternatives that are technically and economically valid and are capable of replacing the use of antibiotics as inhibitors of unwanted fermentation. In the enological field as well, despite not using antibiotics, early bacterial fermentations are a tangible risk to the correct development of yeasts and of the corresponding fermentation step.

Another emerging renewable energy source is the production of biodiesel starting from the extraction and refining of oils from oleaginous crops such as rape, oil palm, castor, cotton, soybean, jatropha. In processes for the production of biodiesel from soybean, but not exclusively, for every 100 units of biofuel one obtains approximately 8 units of crude glycerol, the use of which as a zootechnical feed is expanding rapidly. Biological stabilization of crude glycerol is functional to the storage and distribution thereof from the biodiesel production facilities to the farms or facilities for industrial use. The semiprocessed products are stored in tanks in which contamination and development of unwanted fermentation within the biomass can occur. Microbiological contamination of biodiesel, moreover, is relevant in practice also as regards the main product, which is biodiesel, since the presence of colonies of microorganisms that are dispersed within the mass can entail significant drawbacks as regards the operation of diesel fuel filters of diesel engines.

The need therefore exists to find substances that can minimize or inhibit totally the growth of microorganisms in the biomasses used and whose residues, if any, are compatible with the zootechnical and food use in general of the resulting biomasses, without having the drawbacks of the antibiotics currently used or of expensive preservation treatments.

### SUMMARY OF THE INVENTION

The aim of the present invention is to provide the use of a compound capable of minimizing growth or of inhibiting completely the development of microorganisms in biomasses that can be used for or are the result of, the industrial production of biofuels, allowing on the one hand better and less expensive utilization of biomasses and allowing on the other hand any products or byproducts or derivatives of said biomasses to be compatible with zootechnical use and food use in general.

Another object of the present invention is to provide the use of a compound that is capable of inhibiting the growth of microorganisms in the biomasses that can be used for, or are the result of, the production of biofuels, safeguarding the low cost and production performance of the process.

Another object of the present invention is to provide the use of a compound for inhibiting the growth of bacteria without reducing the growth and productivity of yeasts, particularly for the application to fermentation processes such as those for the production of ethanol in the industrial and enological fields. Another object of the present invention is to provide the use of a compound that can be added together with antibiotic or biocidal substances, possibly increasing their effectiveness, in order to inhibit the growth of microorganisms in biomasses that can be used for, or are the result of, the production of biofuels.

Another object of the present invention is to provide compositions that derive from residues of alcoholic fermentation or agroindustrial transformation, that are suitable for zootechnical use and do not contain residues of drugs or antibiotic substances used in the background art for this purpose, at the same time avoiding a risk for human health arising from the possible onset of antibiotic-resistant bacteria.

Another object of the present invention is to provide a method for limiting the growth of microorganisms within a biomass that can be used for, or is the result of, the production of biofuels, safeguarding the low cost and production performance of the process in which said biomass is used, comprising the addition to the biomass of a compound selected among menadione, menadione derivatives and mixtures thereof.

Another object of the present invention is to provide a method for inhibiting the growth of bacteria without reducing the growth and productivity of yeasts, particularly for the application to fermentation processes such as the ones for the production of ethanol in the industrial and enological field, which comprises the addition of a compound selected among menadione, menadione derivatives and mixtures thereof.

This aim and these and other objects are achieved by means of the use of a compound selected from the group that consists of menadione, menadione derivatives and mixtures thereof to treat biomasses that can be used for, or are the result of, the production of biofuels, in order to limit the growth of unwanted microorganisms.

The aim and objects of the present invention are further achieved by a composition that comprises at least one compound selected from the group that consists of menadione, menadione derivatives and mixtures thereof and at least one yeast, and by the use of said composition to produce ethanol.

The aim and objects are also achieved by a composition that derives from the production of ethanol by fermentation and contains at least one compound selected from the group that consists of menadione, menadione derivatives and mixtures thereof and by the use of said composition for animal feeding.

The aim and objects are further achieved by a process for the treatment of a biomass which can be used for, or is the result of, the production of biofuels, for limiting the growth of microorganisms within the biomass or inhibiting the growth of bacteria without reducing the growth and productivity of yeasts in fermentation processes in a biomass, comprising the addition, to the biomass to be treated, of at least one compound selected from the group that consists of menadione, menadione derivatives and mixtures thereof.

### WAYS OF CARRYING OUT THE INVENTION

The part that follows will describe some embodiments of the invention without intending to limit its scope.

The term “menadione” is used to refer to a naphthoquinone compound, otherwise known as vitamin K3 or 2-methylnaphthalene-1,4-dione (CAS 58-27-5, EINECS 200-372-6), which is known and used, together with a number of derivatives thereof, in animal feeding and in the zootechnical field in general because of its pro-vitamin K activity.

The term “menadione derivatives” is used to refer to all compounds whose structure comprises one or more menadione units, comprising for example but not exclusively salts, coordination compounds, adducts, hydrates and solvates. Non-limiting examples of menadione derivatives are those described in WO 2005/097092 A, U.S. Pat. No. 3,328,169 and IT 1097391.

The term “animals” is used to refer to members of all existing classes of higher animals, preferably mammals and oviparous animals, more preferably human beings and, among the zootechnical species, ruminants and monogastric animals, even more specifically bovines, ovines, caprines, swine, rabbits, avian species or fresh water or salt water fish.

The term “microorganisms” is used to refer to all microorganisms capable of contaminating, for example, biomasses and of establishing processes for the degradation of their carbohydrate content and/or of producing contaminants such as toxins or organic acids. These microorganisms belong equally to prokaryotes and eukaryotes, and in particular can be bacteria, moulds and protozoa.

The terms “biocidal” and “antibacterial” are used to refer to an effect of inhibition of the development or, where present, of the growth of specific microorganisms.

The term “biomass” usable for the production of biofuels or resulting from the production of biofuels is used to refer to a composition that comprises material deriving from living organisms, which can be in the liquid or solid state, and optionally comprises yeasts or microorganisms. The biomass can derive from vegetable living organisms, can be a raw material, a semiprocessed product, an intermediate, a main product, a secondary product of an industrial process. Non-limiting examples of biomasses that can be used for the production of biofuels are still slops, molasses, semiprocessed products of the sugar industry, musts of cereals, grapes or fruit. Moreover, non-limiting examples of biomasses that can be used for the production of biofuels are masses of cereals, seeds, fruit, tubers, roots, stalks of plants, algae, and flours thereof, either solid or dispersed in solution. Non-limiting examples of biomasses that are the result of the production of biofuels are also biodiesel, extraction oils, glycerol, extraction meals, fermentation beds, dried yeasts, distillers, Dried Distillers Grains with Solid walls or DDGS.

The term “comprising” means “included” in addition to “constituted”; for example, a composition “comprising” X can be constituted exclusively by X or can include other additional constituents, for example X+Y.

In a first aspect, the present invention relates to the use of a compound selected from the group that comprises menadione, menadione derivatives, adducts thereof and mixtures thereof for the treatment of biomasses that can be used for, or are the result of, the production of biofuels for limiting the growth of microorganisms.

The inventors have found surprisingly that by using menadione and its derivatives or adducts, or mixtures thereof, in a suitable concentration, it is possible to limit the development of acetic and lactic fermentation of bacterial origin without compromising the vitality and development of other organisms, such as for example yeasts. Moreover, any contamination of the residues of fermentation by menadione and its derivatives and mixtures does not constitute a limitation for the use of such residues in the zootechnical field, since zootechnical feeds are usually supplemented with vitamins, including 0.5-5 ppm of menadione (vitamin K3)(NRC National Research Council Nutrient Requirements of Poultry, ninth revised edition, 1994).

Preferably, said biomass is used for alcoholic fermentation, more preferably for the production of ethanol or alcoholic beverages by means of Saccharomyces.

Menadione and its derivatives or mixtures can be added to the biomass before fermentation begins or during the fermentation. Preferably, menadione and its derivatives or mixtures are added before fermentation begins, with the result of inhibiting from the start the onset of acetic and lactic fermentation of bacterial origin, furthermore keeping intact the saccharide component of the mixture. Preferably, menadione and its derivatives are added to the biomass in order to increase the effectiveness of antibiotics or biocides in cases in which their addition is necessary.

Preferably, said biomass is a product or byproduct of the production of biodiesel or of the extraction of oils of vegetable origin. It has in fact been found that the addition of menadione and derivatives or mixtures to the products of the extraction and refining of oils of vegetable origin for industrial purposes and of the production of biodiesel prevents and inhibits the forming, in said oily biomasses and in their byproducts such as glycerol, the development of fermentation of microbial origin that can lead to their degradation. Moreover, any contamination of refining products and byproducts by menadione and derivatives thereof or mixtures thereof does not constitute a limitation to the use of such residues in the zootechnical field, since zootechnical feeds are usually supplemented with vitamins, including menadione (vitamin K3). More preferably, the biomass is constituted by the glycerol that is the result of the production of biodiesel.

Preferably, the biomass is a semiprocessed product or an intermediate or a byproduct of the extraction of starches and sugars. It has in fact been found that the addition of menadione and derivatives thereof to semiprocessed products or byproducts with a high glucoside content makes it possible to prevent the development of fermentation of microbial origin for the time required for further transformation.

More preferably, the biomass is molasses, still slops, a solution of glucose or dextrose or saccharose or starch.

Compounds that are particularly adapted for these purposes are menadione and water-soluble derivatives such as menadione sodium bisulfite (MSB), menadione potassium bisulfite, menadione nicotinamide bisulfite, menadione dimethylpyrimidinol bisulfite, menadione nicotinic acid bisulfite, menadione piperazine bisulfite, menadione sodium diphosphate and mixtures thereof.

Preferably, the compound is selected from the group that consists of menadione, menadione sodium bisulfite (MSB), menadione dimethylpyrimidinol bisulfite.

More preferably, the compound is menadione or menadione sodium bisulfite (MSB).

The concentrations for use of the compounds in the present invention, expressed as weight of menadione/total weight of the biomass and of the compound, are comprised between 1 and 50,000 ppm, preferably between 1 and 1000 ppm in the case of solid biomasses and between 0.5 and 5000 ppm, preferably between 1 and 1000 ppm, in the case of liquid biomasses.

Preferably, the concentration of said compounds in liquid biomasses containing Saccharomyces cerevisiae is comprised between 1 and 500 ppm expressed as weight of menadione/total weight of the biomass and of the compound, and more preferably between 10 and 400 ppm. It has been found surprisingly that menadione or its derivatives and adducts in a liquid biomass exhibit a biocidal activity on a broad spectrum of microorganisms, including yeasts, starting from concentrations of at least 500 ppm expressed as weight of menadione/total weight of the biomass and of the compound. The presence of menadione in a concentration below 400 ppm allows the growth of Saccharomyces cerevisiae of all the tested strains, whereas at a menadione concentration between 400 and 500 ppm the response varies depending on the tested strains.

In one embodiment of the present invention it is possible to add to the biomass, in addition to menadione and its derivatives and adducts, optionally in a mixture, other compounds as well, for example having a biocidal action, antibiotics and/or additives, emulsifiers, excipients, stabilizing agents and substances useful for the formulation of said compounds, according to procedures that are known to the person skilled in the art, such as for example emulsifiers and alcohols adapted for dispersion of menadione in a liquid biomass, such as for example, but not exclusively, glycerol, oleates of glycerine polyethylene glycol, polyoxyethylene(20)-sorbitan monoleate, sodium dodecyl sulfate, ethyl alcohol, butyl alcohol, or biocides and preservatives such as for example, but not limited to, formic acid, propionic acid, fumaric acid, sorbic acid, benzoic acid, citric acid, benzalkonium and their salts of calcium, sodium, ammonium or potassium or coformulants such as for example, but not limited to, inorganic acids or sodium bisulfite or potassium bisulfite in powder or in solution. In another embodiment of the present invention it is possible to add to the biomass menadione and its derivatives, particularly the water-soluble ones, embedded in matrices that allow their slow and progressive release over time, such as, for example but not exclusively, microencapsulations, nanoencapsulations, cyclodextrins, resins, styramine, clays, silicas, carbons and fossil flours.

Microorganisms that are particularly sensitive to the use of menadione and its derivatives and adducts according to the present invention are bacteria, for example Gram-positive bacteria, such as for example, but not exclusively, bacteria that belong to the genera Bacillus, Lactobacillus, Staphylococcus, Streptococcus, Clostridium, Aerobacter, Gram-negative bacteria such as for example, but not exclusively, bacteria that belong to the genera Escherichia, Pseudomonas, Aeromonas, Salmonella. Other microorganisms that are sensitive to the use of menadione are moulds, such as, but not limited to, the ones that belong to the genera Aspergillus, Penicillum, Claviceps, Candida.

In one embodiment, the present invention relates to a composition that comprises at least one compound selected among menadione, menadione derivatives and mixtures thereof and at least one yeast.

Preferably, the composition according to the present invention comprises at least one compound selected from the group that consists of menadione and menadione sodium bisulfite and at least one yeast selected from the genus Saccharomyces.

More preferably, said composition furthermore comprises at least one further biocidal or antibiotic or preservative substance.

More preferably, the composition according to the present invention comprises at least menadione and at least Saccharomyces cerevisiae.

Another aspect of the present invention relates to the use of a composition that comprises at least one compound selected among menadione, menadione derivatives and mixtures thereof and at least one yeast for the production of ethanol.

Preferably, in the production of ethanol, a composition according to the present invention is used which comprises at least menadione and at least Saccharomyces cerevisiae.

An aspect of the present invention relates to a composition that derives from the process for the production of ethanol by fermentation and comprises at least one compound selected among menadione, menadione derivatives, its adducts and mixtures thereof.

An aspect of the present invention relates to a composition that derives from the production of biodiesel containing menadione, menadione derivatives and mixtures thereof.

An aspect of the present invention relates to a composition that derives from the solubilization of starches or sugars comprising menadione, menadione derivatives and mixtures thereof.

An aspect of the present invention relates to the use of said composition comprising menadione, menadione derivatives and mixtures thereof and derived from the process for the production of ethanol, from the production of biodiesel, from the solubilization of starches or sugars for animal feeding.

Preferably, said compositions are used for feeding swine, poultry, ruminants.

Another aspect of the invention relates to a method for the production of a composition for animal feeding, comprising the addition, to a biomass that is the result of the production of biofuels and is used for animal feeding, of at least one of said compositions comprising menadione, menadione derivatives and mixtures thereof.

Another aspect of the present invention relates to a method for the treatment of a biomass that can be used or is the result of the production of biofuels for limiting the growth of microorganisms in the biomass, which comprises adding to the biomass a compound selected from the group that consists of menadione, menadione derivatives and mixtures thereof.

Preferably, said biomass is a biomass that can be used for alcoholic fermentation.

More preferably, said biomass is a biomass used for the production of ethanol or alcoholic beverages by means of Saccharomyces and the concentration of said compound is comprised between 1 and 500 ppm expressed as weight of menadione/total weight of the biomass and of the compound.

Even more preferably, the concentration of said compound is comprised between 10 and 400 ppm expressed as weight of menadione/total weight of the biomass and of the compound.

Preferably, said method is applied to a biomass which is a product or byproduct of the production of biodiesel or of the extraction of oils of vegetable origin.

More preferably, said biomass is the glycerol that is the result of the production of biodiesel.

Preferably, said method is applied to a biomass that is a semiprocessed product or an intermediate or a byproduct of the extraction of starches or sugars.

More preferably, said biomass is molasses, still slops, a solution of glucose or dextrose or saccharose or starch.

In the method according to the invention, preferably the added compound is selected from the group that consists of menadione, menadione sodium bisulfite (MSB), menadione potassium bisulfite, menadione nicotinamide bisulfite, menadione dimethylpyrimidinol bisulfite, menadione nicotinic acid bisulfite, menadione diphosphate and mixtures thereof.

Preferably, the compound is menadione or menadione sodium bisulfite.

Preferably, in the method according to the invention said compound is present in a concentration, expressed as weight of menadione/total weight of the biomass and of the compound, comprised between 1 and 50,000 ppm.

More preferably, said compound is present in a concentration between 1 and 1000 ppm expressed as weight of menadione/total weight of the biomass and of the compound.

Other characteristics and advantages of the present invention will become better apparent from the examples that follow, intended as non-limiting illustration.

### EXAMPLES

### Example 1

The capacity of menadione sodium bisulfite to contrast the negative effect of bacterial contamination on the production of bioethanol is tested by using a 33% aqueous dispersion of corn flour, which is a typical substrate used in the bioethanol industry.

Using this dispersion, four parts of 40 ml each are prepared and are placed in four separate flasks (procedure described by Bischoff K. M. et al. in Biotechnology and Bioengineering 2009, 103, 117-122).

Flask 1 (witness) receives the addition of 0.5 ml of inoculum (Sc) of Saccharomyces cerevisiae (1×10⁷ ufc/ml). Flask 2 receives the addition of 0.5 ml of inoculum (Sc) of Saccharomyces and 0.5 ml of inoculum (Lf) of Lactobacillus fermentum (1×10⁸ ufc/ml); flask 3 receives the addition of 0.5 ml of inoculum (Sc) of Saccharomyces, 0.5 ml of inoculum (Lf) of Lactobacillus fermentum and 0.5 ml of a solution of virginiamycin with such a titer as to have, in the flask, a concentration of antibiotic equal to 2 mg/l. Flask 4 receives the addition of 0.5 ml of inoculum (Sc) of Saccharomyces, 0.5 ml of inoculum (Lf) of Lactobacillus fermentum and 0.5 ml of a solution of menadione sodium bisulfite (1600 mg/l ) with such a titer as to have in the flask a concentration of MSB equal to 20 ppm by weight.

Then the four flasks are kept under bland agitation and at the temperature of 32° C. for 72 hours. At the end of the incubation period, the four parts are analyzed for their content of ethanol, glucose and lactic acid. The results are given in table 1.

TABLE 1

| | | | Lactic |
|---|---|---|---|
| THESIS | Ethanol g/l | Glucose g/l | acid g/l |
| Flask 1 (Sc) | 109.7 | 6.5 | 0.8 |
| Flask 2 (Sc + Lf) | 83.4 | 43.6 | 3.1 |
| Flask 3 (Sc + Lf + Virg 2 ppm) | 108.2 | 6.4 | 0.4 |
| Flask 4 (Sc + Lf + MSB 20 ppm) | 111.3 | 6.2 | 0.5 |

As is evident, the contamination of the suspension of corn with Lactobacillus fermentum in flask 2 causes a reduction in the production of ethanol of more than 23%, with a sevenfold increase in the concentration of residual (non-fermented) glucose; as a consequence of the growth of Lactobacillus, the fraction of lactic acid is almost quadrupled.

As is predictable, the addition of antibiotic to flask 3 makes it possible to keep the production yield of ethanol unchanged, minimizing the quantity of residual glucose and also minimizing the production of lactic acid. Surprisingly, it has been found that the addition of menadione sodium bisulfite to flask 4 not only has not harmed the growth of the yeast but has also been able to inhibit the bacterial inoculum, so as to produce fermentation results that are comparable with those of the control flask and of the flask that received the addition of virginiamycin.

### Example 2

A 20% solution of molasses is pasteurized at 65° C. for 30 minutes. After cooling, five 50-ml parts are formed: of these, one is kept as a control and the remaining four each receive the addition of 1 ml of inoculum (Lp) of Lactobacillus plantarum (1×10⁵ ufc/ml). The third part then receives the addition of 2 mg/l of virginiamycin, the fourth part receives the addition of 50 ppm of menadione sodium bisulfite, while the fifth part receives the addition of 100 ppm of a mixture of menadione sodium bisulfite and sodium bisulfite known as MSB-C (composition of mixture: 65% MSB and 35% sodium bisulfite). After 48 hours of incubation at 25° C., the five solutions have the microbiological characteristics given in table 2.

TABLE 2

| | Lactic | |
|---|---|---|
| THESIS | acid g/l | Ufc/l |
| Control | 3.20 | <1 × 10⁵ |
| Control + Lp | 9.30 | 5.3 × 10⁸ |
| Control + Lp + Virg. | 0.15 | <1 × 10² |
| Control + Lp + MSB 50 ppm | 0.40 | <1 × 10³ |
| Control + Lp + MSB-C 100 ppm | 0.35 | <1 × 10³ |

As is evident from the table, in the control solution inoculated with Lactobacillus, the molasses is attacked by the bacterial inoculum, the metabolism of which causes a conspicuous production of lactic acid and a drastic increase in the bacterial load. As is predictable, the addition of antibiotic blocks the growth of the bacterial load (indeed, in practice a reduction in the initial load occurs) and consequently prevents the production of lactic acid. Surprisingly, it is found that the addition of menadione sodium bisulfite, but also the addition of the MSB-C composition, are capable of inhibiting completely the bacterial inoculum, keeping the production of lactic acid at minimal values.

### Example 3

A 30% solution of glycerol is pasteurized at 65° C. for 30 minutes. After cooling, four 50-ml parts are formed, each of which receives the addition of 1 ml of inoculum (00) of Oenococcus oeni, so as to have a bacterial load of 1×10⁵ ufc/l.

The first part is kept as a control; the second part receives the addition of 10 mg/l of Penicillin (Pen); the third part receives the addition of 20 mg/l of an emulsion A of menadione (composition: 50% menadione, 50% ethanol); the fourth part receives the addition of 150 mg/l of an emulsion B of menadione (composition: menadione 10%, ricinoleate 90%). After 48 hours of incubation at 25° C., the five solutions have the microbiological characteristics given in table 3.

TABLE 3

| THESIS | Ufc/l |
|---|---|
| Control | <1 × 10⁴ |
| Control + Oo | 6.3 × 10⁸ |
| Control + Oo + Pen | <1 × 10² |
| Control + Oo + Emulsion A | <1 × 10³ |
| Control + Oo + Emulsion B | <1 × 10³ |

As is evident from the table, in the control solution inoculated with Oenococcus the mass is attacked by the bacterial inoculum, which causes a drastic increase in bacterial load. As is predictable, the addition of antibiotic blocks the growth of the bacterial load and indeed reduces its value. Surprisingly, it has been found that the addition of menadione in the form of various types of emulsion instead is capable of inhibiting totally the bacterial inoculum, keeping the production of lactic acid at minimal values.

The disclosures of Italian invention patent application no. MI2010A000497, from which this application claims priority, are incorporated herein by reference.

1-19. (canceled)

20. A method for limiting the growth of microorganisms in a biomass that can be used for, or is the result of, the production of biofuels, the method comprising treating said biomass with a compound selected from the group constituted by menadione, menadione derivatives and mixtures thereof

21. The method according to claim 20, wherein the biomass can be used for alcoholic fermentation.

22. The method according to claim 20, wherein the biomass is a product or a byproduct of the production of biodiesel or of the extraction of oils of vegetable origin.

23. The method according to claim 22, wherein the biomass is the glycerol that is result of the production of biodiesel.

24. The method according to claim 20, wherein the biomass is a semiprocessed product or an intermediate or a byproduct of the extraction of starches or sugars.

25. The method according to claim 24, wherein the biomass is molasses, still slops, a solution of glucose or dextrose or saccharose or starch.

26. The method according to claim 20, wherein the compound is selected from the group that consists of menadione, menadione sodium bisulfite (MSB), menadione potassium bisulfite, menadione nicotinamide bisulfite, menadione dimethylpyrimidinol bisulfite, menadione nicotinic acid bisulfite, menadione diphosphate and mixtures thereof

27. The method according to claim 20, wherein the compound is menadione.

28. The method according to claim 20, wherein the compound is menadione sodium bisulfite.

29. The method according to claim 20, wherein said compound is present in a concentration, expressed as weight of menadione/total weight of the biomass and of the compound, comprised between 1 ppm and 50,000 ppm.

30. The method according to claim 29, wherein said compound is present in a concentration between 1 and 1000 ppm expressed as weight of menadione/total weight of the biomass and of the compound.

31. The method according to claim 30, wherein the biomass can he used for the production of ethanol or alcoholic beverages by means of Saccharomyces and the concentration of said compound is comprised between 1 and 500 ppm expressed as weight of menadione/total weight of the biomass and of the compound.

32. The method according to claim 31, wherein the concentration of said compound is comprised between 10 and 400 ppm expressed as weight of menadione/total weight of the biomass and of the compound.

33. A composition comprising at least one compound selected among menadione, menadione derivatives and mixtures thereof and at least one yeast.

34. The composition according to claim 33, wherein at least one compound is menadione sodium bisulfite, at least one yeast is Saccharomyces cerevisiae and the concentration of said compound expressed as weight of menadione/total weight of the biomass and of the compound is comprised between 1 and 500 ppm.

35. A composition deriving from the production of bioethanol or from the production of biodiesel or from the solubilization of starches or sugars and containing at least one compound selected among menadione, menadione derivatives and mixtures thereof.

36. A composition for animal feeding, comprising a composition according to claim 35.
